(19) United States
(12) Patent Application Publication
(10) Pub. No.: US 2006/0293399 A1
(43) Pub. Date: Dec. 28, 2006

(54) Electrical apparatus with a foamed stiffener and manufacturing method thereof

(75) Inventor: Chia-Huang Chan, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/434,808

(22) Filed: May 17, 2006

(30) Foreign Application Priority Data
Jun. 23, 2005 (TW) 94121051

(51) Int. Cl. B29C 44/12

(52) U.S. Cl. 521/54

(57) ABSTRACT

An electrical apparatus is provided, which comprises a shell with an electrical device inside. A liquid foam is injected into the shell. After performing a foaming method, the liquid foam becomes a foamed stiffener. The foaming method comprises adding a chemical blowing agent or injecting gas into the liquid foam to uniformly distribute the gas in the liquid foam. After the foaming method, the foamed stiffener, which is inside the shell, covers or surrounds the electrical device. The foamed stiffener is used to support and strengthen the shell. In some cases, the foamed stiffener is flexible; therefore, the foamed stiffener can absorb impact to protect the electrical device from damage.

### RELATED APPLICATIONS

The present application is based on, and claims priority from, Taiwan Application Serial No. 94121051, filed Jun. 23, 2005, the disclosure of which is hereby incorporated by reference herein in its entirety.

### BACKGROUND

1. Field of Invention

The present invention relates to an electrical apparatus with stiffener. More particularly, the present invention relates to an electrical apparatus having sufficient mechanical strength.

2. Description of Related Art

As the market of electrical apparatuses becomes more competitive, making more varied styles of shells to house the apparatuses becomes more important. Traditionally, the shell of the electrical apparatus is provided by injection molding, casting, or stamping, such that the electrical apparatus not only has sufficient strength but also can be varied in appearance. The manufacturing technology of electrical apparatuses has improved along with advances of electrical technology in recent years. Almost all electrical apparatuses need to be lightweight and small to meet the desire of modern people for operating apparatuses conveniently.

The shell thickness of the electrical apparatus is reduced in order to shed weight, but doing so weakens the strength of the apparatus, allowing the apparatus to be easily damaged. Therefore, the shell of the typical electrical apparatus has ribs mounted for reducing the stress loaded on the shell and thus improving the strength of the electrical apparatus.

The ribs mounted on the shell, however, reduce the interior volume of the electrical apparatus. In addition, the ribs are mounted on the shell by using welds, rivets, ultrasonic welds, glue, or screws; that is, the ribs are mounted on the shell by additional methods.

Moreover, the electrical apparatus often needs to be configured with some special patterns or characters on the shell, for example, trademarks. Those patterns or characters further reduce the strength of the shell. It needs to be compensated for by extra design in order to pass the product examination.

For the foregoing reasons, there is a need for avoiding additional methods and extra design to reduce the cost and shorten the design period.

### SUMMARY

It is therefore an aspect of the present invention to provide an electrical apparatus with a foamed stiffener and a manufacturing method thereof, such that the electrical apparatus not only has sufficient strength but also varied looks.

It is another aspect of the present invention to provide an electrical apparatus with a foamed stiffener and a manufacturing method thereof for improving the strength of the electrical apparatus without ribs being mounted.

It is still another aspect of the present invention to provide an electrical apparatus with a foamed stiffener and a manufacturing method thereof for reducing the weight of the electrical apparatus and having sufficient strength without ribs being mounted.

It is yet another aspect of the present invention to provide an electrical apparatus with a foamed stiffener and a manufacturing method thereof for simplifying the manufacturing method of the electrical apparatus and thus reducing the cost and shortening the design period.

It is still another aspect of the present invention to provide a method for forming a foamed stiffener in an electrical apparatus for improving the strength of the electrical apparatus without extra design and thus reducing the cost and shortening the design period.

In accordance with the foregoing and other aspects of the present invention, an embodiment of an electrical apparatus with a foamed stiffener is provided. The electrical apparatus has a shell, an electrical device configured in the shell, and a foamed stiffener covering or surrounding the electrical device. The foamed stiffener supports the shell and protects the electrical device from damage.

In accordance with the foregoing and other aspects of the present invention, an embodiment of a method for forming a foamed stiffener in an electrical apparatus is provided. First, a liquid foam is injected into the shell of the electrical apparatus in which an electrical device is configured. The liquid foam is foamed to become a foamed stiffener for supporting the shell after injecting the liquid foam into the shell. The foamed stiffener covers or surrounds the electrical device for improving the strength of the electrical apparatus and protecting the electrical device from damage.

In accordance with one preferred embodiment of present invention, the shell can be made of soft or hard material. Thus, a mold needs to be provided, and then the shell in which the electrical device is configured is positioned in the mold before injecting the liquid foam into the shell. In addition, the shell in which the electrical device and the foamed stiffener are positioned is taken out from the mold after foaming the liquid foam. Then, the shell has sufficient strength by the foamed stiffener to bear pressure and impact.

In some embodiments, the invention allows absorbing impact by the foamed stiffener for protecting the electrical device from damage. Furthermore, the electrical apparatus which has the foamed stiffener is more competitive because the foamed stiffener is lightweight and thus the weight of the electrical apparatus is reduced. The electrical apparatus with foamed stiffeners is less costly to produce and also can easily be varied in appearance.

Moreover, the liquid foam can be made to become foamed plastic or rigid foam; or an anti-static electricity foam by, for example, adding anti-static electricity agent, foamed Aluminum alloys or anti-static electricity foamed plastic.

It is to be understood that both the foregoing general description and the following detailed description are by examples and are intended to provide further explanation of the invention as claimed.

### BRIEF DESCRIPTION OF THE DRAWINGS

The invention can be more fully understood by reading the following detailed description of the preferred embodiment with reference made to the accompanying drawings as follows:

FIGS. 1-6 are cross-sectional diagrams of steps of the method for forming a foamed stiffener according to one preferred embodiment of this invention; and

FIG. 7 is an exploded view of the electrical apparatus according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

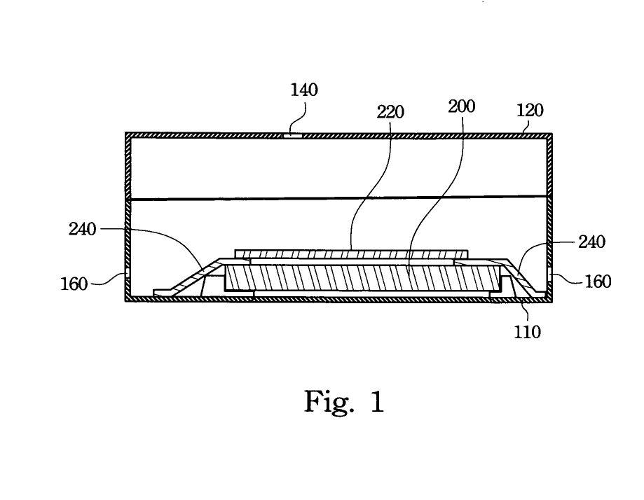

Reference is made to FIGS. 1-6, which are cross-sectional diagrams of steps of the method for forming a foamed stiffener according to one preferred embodiment of this invention. The method of the preferred embodiment for forming a foamed stiffener can be used for manufacturing any product which needs to be protected, and especially for manufacturing an electrical apparatus.

First, as shown in FIG. 1, an electrical device 200 is configured in a bottom envelope 110 of an electrical apparatus. The electrical device 200 can comprise an electrical circuit or an electrical module. Metal foils 240 are partially approximated to the electrical device 200, and an insulator 220 is partially positioned on the metal foils 240. The metal foils 240 are used for reducing electromagnetic interference. In addition, a cover encloses and protects the electrical device 200, the metal foils 240, and the insulator 220.

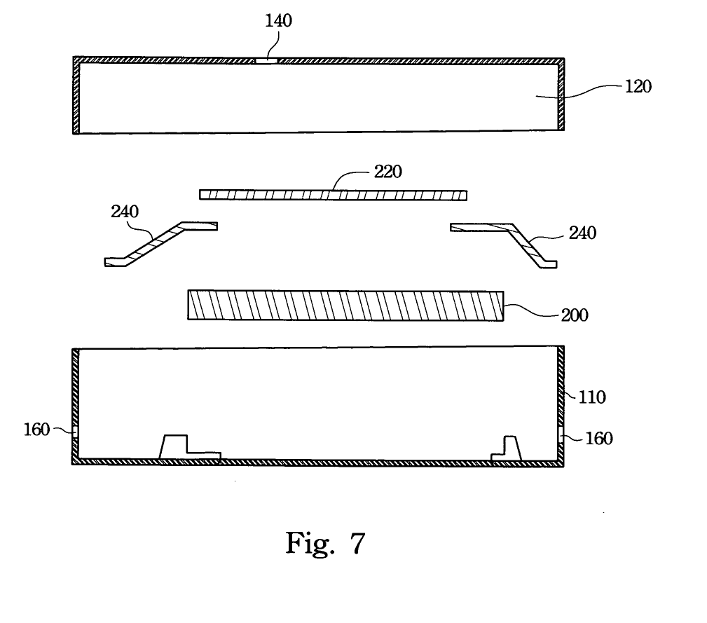

Reference is made to FIG. 7, which is an exploded view of the electrical apparatus according to one preferred embodiment of this invention. A top envelope 120 is mounted on the bottom shell 110 to form a shell after positioning the metal foils 240 and the insulator 220. A shell filler point 140 is mounted on the top envelope 120 for injecting a liquid foam into the shell. A pair of shell exhausts 160 is mounted on both side walls of the bottom envelope 110 for exhausting gas when injecting the liquid foam into the shell. Alternatively, the shell filler point 140 and the shell exhausts 160 can be mounted on any position of the shell.

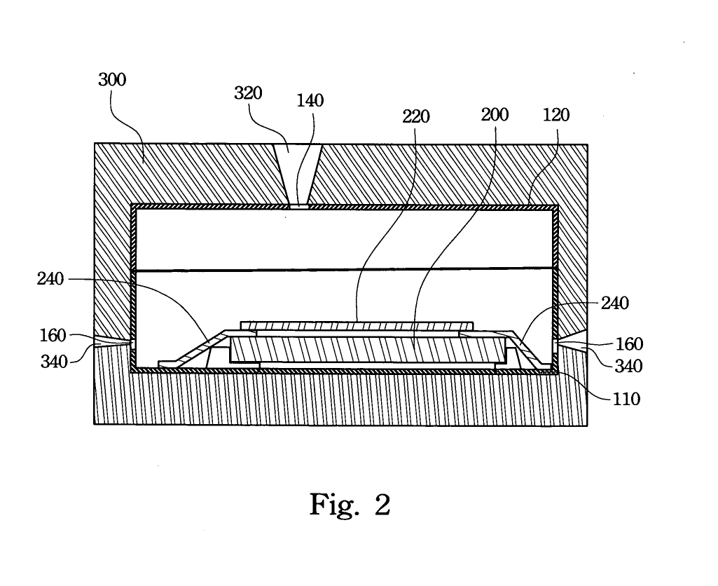

Referring to FIG. 2, the shell in which the electrical device 200 is configured is positioned in a mold 300 in order to facilitate both soft and hard shell material. A mold filler point 320 is included on the mold 300 and connects to the shell filler point 140 for injecting the liquid foam into the shell. A pair of mold exhausts 340 are included on the mold 300 and connect to the shell exhausts 160 for exhausting gas when injecting the liquid foam into the shell.

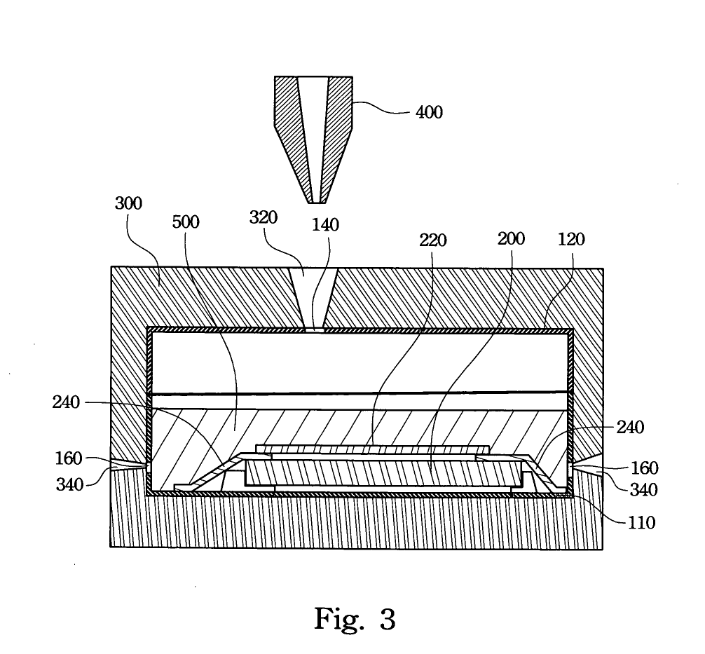

Referring to FIG. 3, a liquid foam 500 is injected into the shell by a nozzle 400 after configuring the electrical device 200 into the shell. The liquid foam can comprise rigid foam such as polyurethane, polystyrene, cellular cellulose acetate, thermosetting plastic, syntactic foam, or metal. The foamed stiffener foamed from rigid foam has more strength for supporting the shell. Alternatively, the liquid foam can comprise foamed plastic such as polyurethane, vinyl foams, cellular polyethylene, or silicone foam. The liquid foam preferably comprises polyurethane or vinyl foams. The foamed stiffener foamed from foamed plastic is flexible and can protect the electrical device 200 from damage.

Moreover, the liquid foam 500 can include conductive particles for anti-static capability. Alternatively, the liquid foam can include anti-static electricity foam made by, for example, foamed Aluminum alloys or anti-static electricity foamed plastic.

The amount of the liquid foam 500 injected into the shell is determined by the required mechanical properties. For example, if a comparatively small amount of the liquid foam 500 is injected into the shell, the foamed degree of the following foam method is comparatively high and thus the resulting foamed stiffener is comparatively flexible; that is, the Young's modulus of the foamed stiffener is comparatively small.

On the other hand, if a comparatively large amount of the liquid foam 500 is injected into the shell, the foamed degree of the following foam method is comparatively low and thus the resulting foamed stiffener is comparatively hard; that is, the Young's modulus of the foamed stiffener is comparatively large. Besides, the liquid foam 500 can be injected into a certain portion of the shell volume to form a foamed stiffener for supporting that portion.

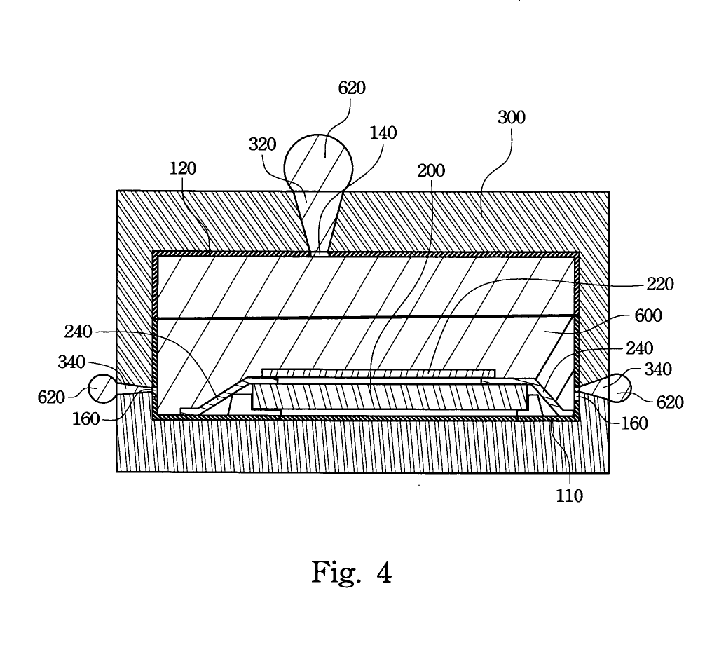

Referring to FIG. 4, the liquid foam 500 is foamed to become a foam stiffener 600 for supporting the shell after injecting the liquid foam 500 into the shell. This foam method can be done by adding a chemical blowing agent or directly injecting gas into the liquid foam 500. Either method lets gas uniformly distribute within the liquid foam 500 to foam it into becoming the foamed stiffener 600.

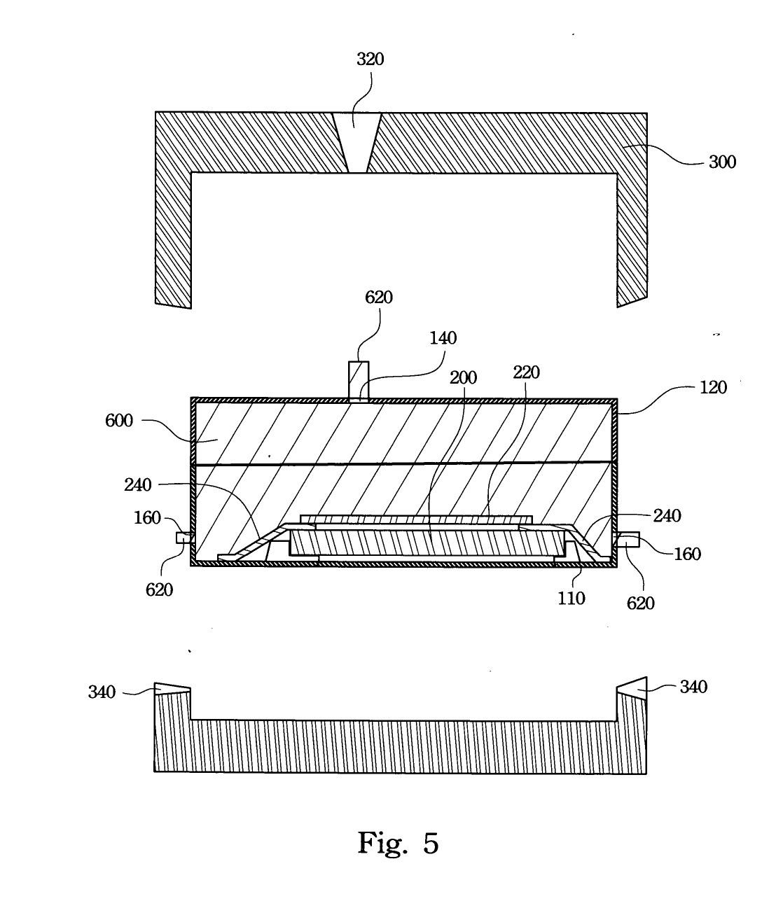

Referring to FIG. 5, the mold 300 is opened and the shell is taken out from the mold 300 after foaming the liquid foam 500. There are some leaked foamed structures 620 proximal to the shell filler point 140 and the shell exhausts 160.

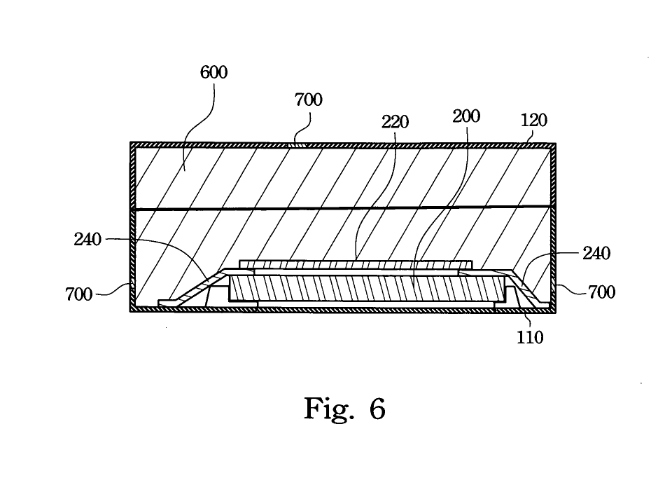

Referring to FIG. 6, the leaked foamed structures 620 proximal to the shell filler point 140 and the shell exhausts 160 are trimmed after taking the shell out. Optionally, plugs 700 can be configured on the shell filler point 140 and the shell exhausts 160.

According to one preferred embodiment of present invention, the foamed stiffener can support the electrical apparatus such that the shell of the electrical apparatus has sufficient strength, and thus the foamed stiffener can protect the electrical device in the electrical apparatus from damage. In addition, according to another embodiment of present invention, the foamed stiffener is flexible, and thus the foam stiffener can absorb impact to protect the electrical device in the electrical apparatus from damage. Besides, according to still another embodiment of present invention, the liquid foam 500 can be injected into a specific portion of the shell volume to form a foamed stiffener for supporting that portion and thus the mechanical strength of the whole electrical apparatus is improved.

In conclusion, the present invention allows:

(1) improving the mechanical strength of the shell of the electrical apparatus and supporting the shell because the foamed stiffener has sufficient mechanical strength;

(2) absorbing impact by using the foamed stiffener and thus protecting the electrical device in the electrical apparatus from damage because the foamed stiffener is flexible;

(3) letting the electrical apparatus remain lightweight and small in consideration of the sufficient mechanical strength of the electrical apparatus imparted by the lightweight foamed stiffener;

(4) reducing the cost of the electrical apparatus because the method for forming a stiffener is easily practiced; and

(5) providing varied looks for allowing the electrical apparatus to be more competitive because the shell of the electrical apparatus can be made of soft material.

Although the present invention has been described in considerable detail with reference to certain preferred embodiments thereof, other embodiments are possible. Therefore, their spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for forming a foamed stiffener, the method comprising:
providing a shell;
configuring an electrical device into the shell;
injecting a liquid foam into the shell; and
foaming the liquid foam to become the foamed stiffener for supporting the shell.

2. The method of claim 1, further comprising:
providing a cover covering the electrical device for protecting the electrical device before injecting the liquid foam into the shell.

3. The method of claim 1, wherein the shell comprises:
a shell filler point included on the shell for injecting the liquid foam into the shell; and
at least one shell exhaust included on the shell for exhausting gas when injecting the liquid foam into the shell.

4. The method of claim 3, further comprising:
providing a mold having a cavity in which the shell is positioned before injecting the liquid foam into the shell; and
opening the mold and taking the shell out after foaming the liquid foam;
wherein the mold comprises:
a mold filler point included on the mold and connecting to the shell filler point for injecting the liquid foam into the shell; and
at least one mold exhaust included on the mold and connecting to the shell exhaust for exhausting gas when injecting the liquid foam into the shell.

5. The method of claim 4, further comprising:
modifying the shell filler point and the shell exhaust after opening the mold and taking the shell out.

6. The method of claim 5, further comprising:
configuring at least one plug on the shell filler point and the shell exhaust after modifying the shell filler point and the shell exhaust.

7. The method of claim 1, wherein the liquid foam comprises a foamed plastic or a rigid foam.

8. The method of claim 7, wherein the foamed plastic is selected from the group consisting of polyurethane, vinyl foams, cellular polyethylene, and silicone foam.

9. The method of claim 7, wherein the rigid foam is selected from the group consisting of polyurethane, polystyrene, cellular cellulose acetate, thermosetting plastic, syntactic foam, and metal.

10. The method of claim 1, wherein foaming the liquid foam is done by adding chemical blowing agent.

11. The method of claim 1, wherein foaming the liquid foam is done by injecting gas into the liquid foam.

12. An electrical apparatus comprises:
a shell;
an electrical device configured in the shell; and
a foamed stiffener positioned in the shell for supporting the shell.

13. The electrical apparatus of claim 12, further comprising:
a cover covering the electrical device.

14. The electrical apparatus of claim 12, wherein the foamed stiffener is positioned proximally to the electrical device for protecting the electrical device.

15. The electrical apparatus of claim 12, wherein the foamed stiffener comprises a foamed plastic or a rigid foam.

16. The electrical apparatus of claim 15, wherein the foamed plastic is selected from the group consisting of polyurethane, vinyl foams, cellular polyethylene, and silicone foam.

17. The electrical apparatus of claim 15, wherein the rigid foam is selected from the group consisting of polyurethane, polystyrene, cellular cellulose acetate, thermosetting plastic, syntactic foam, and metal.

18. A method for forming a foamed stiffener in an electrical apparatus, the electrical apparatus having a shell, the method comprising:
injecting a liquid foam into the shell; and
foaming the liquid foam to become the foamed stiffener for supporting the shell after injecting the liquid foam into the shell.

19. The method of claim 18, wherein the shell comprises:
a shell filler point included on the shell for injecting the liquid foam into the shell; and
at least one shell exhaust included on the shell for exhausting gas when injecting the liquid foam into the shell.

20. The method of claim 18, wherein the liquid foam comprises a foamed plastic or a rigid foam.

21. The method of claim 20, wherein the foamed plastic is selected from the group consisting of polyurethane, vinyl foams, cellular polyethylene, and silicone foam.

22. The method of claim 20, wherein the rigid foam is selected from the group consisting of polyurethane, polystyrene, cellular cellulose acetate, thermosetting plastic, syntactic foam, and metal.

23. The method of claim 18, wherein foaming the liquid foam is done by adding chemical blowing agent.
